(19) United States
(12) Patent Application Publication
(10) Pub. No.: US 2024/0222683 A1
(43) Pub. Date: Jul. 4, 2024

(54) Electrode Assembly, Method for Manufacturing the Same, and Manufacturing Apparatus Therefor

(71) Applicant: LG Energy Solution, Ltd., Seoul (KR)

(72) Inventors: Jong Seok Kim, Daejeon (KR); Nam Young Kim, Daejeon (KR); Yong Nam Kim, Daejeon (KR); Se Hyun Yoon, Daejeon (KR); Ju Young Lee, Daejeon (KR); Jongkwan Choi, Daejeon (KR)

(73) Assignee: LG Energy Solution, Ltd., Seoul (KR)

(21) Appl. No.: 18/403,211

(22) Filed: Jan. 3, 2024

(30) Foreign Application Priority Data
Jan. 3, 2023 (KR) 10-2023-0000716
Apr. 28, 2023 (KR) 10-2023-0056378

(51) Int. Cl. H01M 10/04; B23K 20/02; H05B 6/10; H05B 6/44

(52) U.S. Cl. CPC H01M 10/0459; B23K 20/023; H01M 10/0404; H05B 6/10; H05B 6/44

(57) ABSTRACT

A method for manufacturing an electrode assembly includes assembling an electrode stack, applying induction heating to a central portion of the stack, and applying heat and pressure to top and bottom portions of the stack, so as to bond the component electrodes and separator of the stack to one another. The method also includes applying induction heating to at least an electrode tab of the stack. An apparatus for manufacturing the electrode assembly includes an electrode tab heating unit configured to apply the induction heating to the electrode tab. The resulting electrode assembly has improved uniformity of properties, including small deviations in thickness of the separator between a central portion and an outer portion of the stack along the stacking axis.

### CROSS-REFERENCE TO RELATED APPLICATIONS

This application claims priority to and the benefit of Korean Patent Application No. 10-2023-0000716 filed in the Korean Intellectual Property Office on Jan. 3, 2023, and Korean Patent Application No. 10-2023-0056378 filed in the Korean Intellectual Property Office on Apr. 28, 2023, the entire contents of which are incorporated herein by reference.

The subject matter of this application relates to that disclosed in Korean Patent Application No. 10-2023-0000712 filed on Jan. 3, 2023 and Korean Patent Application No. 10-2023-0058195 filed on May 4, 2023, the entire contents of both of which are also incorporated herein by reference.

### TECHNICAL FIELD

The present invention relates to an electrode assembly, a method for manufacturing the electrode assembly, and a manufacturing apparatus for manufacturing the electrode assembly.

### BACKGROUND ART

Unlike a primary battery, a secondary battery can be recharged and may be formed in a small size or with a large capacity. Accordingly, a lot of research and development on secondary batteries are currently in progress. Along with the technology development and the increase in demand for mobile devices, the demand for secondary batteries as an energy source is sharply increasing.

Secondary batteries are classified into coin type batteries, cylindrical type batteries, prismatic type batteries, and pouch type batteries, according to a shape of a battery case. In a secondary battery, an electrode assembly mounted inside a battery case is a chargeable and dischargeable power generating device having a structure in which an electrode and a separator are stacked.

The electrode assembly may be generally classified into a jelly-roll type electrode assembly, a stack-type electrode assembly, and a stack and folding type electrode assembly. In a jelly-roll electrode assembly, a separator is interposed between a positive electrode and a negative electrode, each of which is provided in the form of a sheet coated with an active material, and then, the positive electrode, the separator, and the negative electrode are wound. In a stack-type electrode assembly, a plurality of positive and negative electrodes with a separator therebetween are sequentially stacked. In a stack and folding-type electrode assembly, stack-type unit cells are wound with a separation film having a long length.

In the stack and folding-type electrode assembly, the separator is folded and stacked in a zigzag form, and the positive electrode or the negative electrode is inserted between folds of the separator. As a result, an electrode assembly in which the positive electrode, the separator, and the negative electrode are stacked is manufactured.

In the above process, in order to bond the electrodes and the separator to one another, heat and pressure are applied to the stack in which the positive electrode, the separator, and the negative electrode are stacked. However, it can take a long time and a lot of energy to bond the electrodes (positive electrode, negative electrode) and the separator in the stack by applying heat and pressure to the stack. Moreover, when applying heat and pressure to the stack, there can result a problem in that heat and pressure cannot be uniformly applied regardless of the stacked positions of the electrodes and separator due to difference in stacked positions (stacked heights) of the electrodes and separator in the stack. That is, there can occur a problem in that adhesive force between the separator and the electrodes is not constant. As a result, the performance of the electrode assembly may not be uniform.

### SUMMARY OF THE INVENTION

The present invention has been made in an effort to provide an electrode assembly, a method for manufacturing the same, and a manufacturing apparatus therefor for addressing problems caused due to non-uniform adhesive force between the electrodes and separator within the electrode assembly.

An exemplary aspect of the present invention provides a method for manufacturing an electrode assembly, the electrode assembly including first electrodes, a separator, and second electrodes, the method including: stacking a stack including the first electrodes, the separator, and the second electrodes on a stack table; inductively heating the stack; and heating and pressing the inductively heated stack, in which at least one of the first electrodes of the stack includes a first electrode tab, in which at least one of the second electrodes of the stack includes a second electrode tab, and in which the method further includes performing an electrode tab induction heating by inductively heating at least one of the first electrode tab and the second electrode tab between the induction heating and the heating and pressing. Another exemplary aspect of the present invention provides an electrode assembly manufacturing apparatus for manufacturing an electrode assembly including first electrodes, a separator, and second electrodes, the electrode assembly manufacturing apparatus including: a stack table on which the first electrodes, the separator, and the second electrodes are stacked, and thus, a stack including the first electrodes, the separator and the second electrodes is placed; and a heating and pressing unit configured to heat and press the stack, in which at least one of the first electrodes of the stack includes a first electrode tab and at least one of the second electrodes of the stack includes a second electrode tab, and in which the electrode assembly manufacturing apparatus further includes an induction heating unit configured to inductively heat the stack while conveying the stack from the stack table to the heating and pressing unit, and an electrode tab induction heating unit configured to inductively heat at least one of the first electrode tab and the second electrode tab before heating and pressing the stack, which has been inductively heated in the induction heating unit, in the heating and pressing unit.

Still another exemplary aspect of the present invention provides an electrode assembly including a first electrode, a separator, and a second electrode, in which the electrode assembly is stacked in a zigzag form, in which the separator is compressed after the zigzag stacking, and in which a compression rate of the separator located at the outermost of the electrode assembly is greater than a compression rate of the separator located in the middle of the electrode assembly, and a difference in compression rate is 3% p.

The electrode assembly manufacturing method and the electrode assembly manufacturing apparatus according to the exemplary aspects of the present application can shorten the time required to manufacture the electrode assembly.

Since the electrode assembly manufacturing method and the electrode assembly manufacturing apparatus according to the exemplary aspects of the present application can easily adjust a temperature of the electrode to a specific temperature range to reduce a temperature deviation between the electrodes, it is possible to provide an electrode assembly with uniform performance.

The electrode assembly according to the exemplary aspect of the present application has a small air permeability deviation of the separator depending on the position, and therefore, has the advantage of uniform performance.

In accordance with other aspects of the present invention, a method for manufacturing an electrode assembly is provided. The method according to such aspects preferably includes the steps of stacking a first electrode, a separator, and a second electrode into a stack along a stacking axis, where the first electrode includes a first electrode tab. The method desirably also includes the steps of: (1) applying heat from a first source of heat to a first portion of the stack; (2) applying heat from a second source of heat to a second portion of the stack while applying pressure to the stack; and (3) applying heat from a third source of heat to the first electrode tab. Preferably the first, second, and third sources of heat are controllable independently of one another.

In accordance with some aspects of the method, a step of stopping the application of heat from the first source to the first portion of the stack may further be performed for a predetermined time period. Such step of stopping the application of heat to the first portion of the stack desirably occurs between the step of applying heat from the first source to the first portion of the stack and the step of applying heat from the second source to the second portion of the stack. Moreover, in accordance with at least some aspects of the method, such predetermined time period may be in a range from 3 seconds to 60 seconds.

In accordance with some other aspects of the method, the step of applying heat from the third source of heat to the first electrode tab desirably occurs between the step of applying heat from the first source to the first portion of the stack and the step of applying heat from the second source of heat to the second portion of the stack. In accordance with some of such aspects of the method, the step of applying heat from the third source of heat to the first electrode tab desirably occurs after stopping the application of heat from the first source to the first portion of the stack for the predetermined time period.

In accordance with yet further aspects of the method, the third source of heat may be an induction heating coil, such that the step of applying heat from the third source of heat to the first electrode tab involves applying induction heating from the induction heating coil to the first electrode tab. In accordance with yet other of such aspects of the method, the first source of heat may be a second induction heating coil, such that the step of applying heat from the first source of heat to the first portion of the stack comprises applying induction heating from the second induction heating coil to the first portion of the stack.

In accordance with even further aspects of the method, the step of applying heat from the second source of heat to the second portion of the stack desirably includes applying direct heating by conduction and/or radiation to the second portion of the stack. In accordance with some of such aspects of the method, the second portion of the stack may be at least one of the top and bottom portions of the stack along the stacking axis, while the first portion of the stack may be a central portion of the stack disposed between the top and bottom portions along the stacking axis.

In accordance with some other aspects of the method, the step of applying induction heating may be performed for a time period in a range from 1 second to 60 seconds.

In accordance with other aspects of the invention, an apparatus for manufacturing an electrode assembly is provided. The apparatus according to such aspects preferably includes a stack table on which a first electrode, a separator, and a second electrode are configured to be stacked into a stack. The apparatus desirably also includes a heating and pressing unit configured to apply heat and pressure to the stack, as well as an electrode tab heating unit configured to apply heat to the first electrode tab. Preferably such application of heat to the first electrode tab is controllable independently of the heat applied by the heating and pressing unit.

In accordance with some aspects of the apparatus, the electrode tab heating unit may include an induction heating coil for applying induction heating to the first electrode tab. In accordance with other aspects of the apparatus, the apparatus may further include an induction heating unit including a second induction heating coil configured to apply induction heating to the stack. In accordance with still other aspects of the apparatus, the heating and pressing unit may include a non-inductive heat source for applying conduction and/or radiation to the stack.

In accordance with yet other aspects of the invention, an electrode assembly is provided. The electrode assembly according to such aspects preferably includes a plurality of electrodes arranged in a stack along a stacking axis, where each of the electrodes in the stack is separated along the stacking axis from a successive one of the electrodes in the stack by a respective separator portion positioned therebetween. The separator portions of the electrode assembly desirably include a first separator portion and a second separator portion, where the first separator portion is positioned in a central portion of the stack between a top portion and a bottom portion of the stack along the stacking axis, and the second separator portion is positioned in at least one of the top and bottom portions of the stack along the stacking axis. The second separator portion preferably has a second thickness from 1 to 1.09 times a first thickness of the first separator portion. More preferably the second thickness of the second separator portion is from 1 to 1.05 times the first thickness of the first separator portion. Even more preferably the second thickness of the second separator portion is from 1 to 1.03 times the first thickness of the first separator portion.

In accordance with some aspects of the electrode assembly, the first and second separator portions may be portions of an elongated separator sheet which is folded between each of the separator portions such that the elongated separator sheet follows a serpentine path traversing back and forth along an orthogonal dimension orthogonal to the stacking axis so as to extend between each successive one of the electrodes in the stack.

In accordance with other aspects of the electrode assembly, the electrode assembly may have a full length in a range from 400 mm to 600 mm and a full width in a range from 50 mm to 150 mm.

In accordance with yet other aspects of the electrode assembly, the first and second separator portions may each have an air permeability in a range from 80 sec/100 ml to 120 sec/100 ml.

### BRIEF DESCRIPTION OF THE DRAWINGS

FIG. 1 is a side elevation view illustratively showing an electrode assembly manufacturing apparatus according to an exemplary embodiment of the present invention.

FIG. 2 is a top plan view showing a concept of the electrode assembly manufacturing apparatus according to the exemplary embodiment of the present invention.

FIG. 3 is a cross-sectional side elevation view illustratively showing a general electrode assembly.

FIGS. 4, 5, and 6 are views illustratively showing a process of applying an electrode assembly manufacturing method or manufacturing apparatus according to an exemplary embodiment of the present invention.

FIG. 7 is a schematic view illustratively showing an induction heating unit according to an exemplary embodiment of the present invention.

Part (a) of FIG. 8 is a perspective view showing a first heating and pressing unit 50 according to an exemplary embodiment of the present invention.

Part (b) of FIG. 8 is a perspective view showing a second heating and pressing unit 60 according to an exemplary embodiment of the present invention.

FIG. 9 is a diagram showing a result of measurement of a surface temperature change of a stack during a process of manufacturing an electrode assembly according to an exemplary embodiment of the present invention.

FIG. 10 is a diagram showing an adhesive force pattern of an electrode assembly according to an exemplary embodiment of the present invention.

### DETAILED DESCRIPTION

Hereinafter, exemplary embodiments of the present invention will be described in detail such that one skilled in the art to which the present invention belongs can readily implement the same. However, the present invention may be embodied in various different forms, and is not limited to the configurations described herein.

When one part “includes”, “comprises” or “has” one constituent element in the present specification, unless otherwise specifically described, this does not mean that another constitutional element is excluded, but rather means that another constitutional element may be further included.

In an exemplary embodiment of the present invention, the electrode assembly may be stacked in such a form that the first electrode and the second electrode are alternately arranged between folds of the folded separator. That stacking form is referred to herein as zigzag stacking. In such form of stacking, the folded separator may refer to a separator that is stacked while overlapping in a zigzag form. More specifically, the separator is stacked in a zigzag form in which the separator is folded back and forth across the stacking axis between right and left sides of the stack. Further, the stacking includes the first electrode and the second electrode being alternately arranged between successive folds of the stacked separator. The stacking axis refers to a virtual axis parallel to a direction in which the first electrode, the separator, and the second electrode are stacked, and passing through a center of a stack in which the electrodes and the separator are stacked. Stated another way, the separator is provided as a single strip elongated along a longitudinal direction, and intermittent folds may be formed in the elongated strip along a direction perpendicular to the longitudinal direction, were each successive fold may be formed in an opposing direction to the previous fold. Alternating positive and negative electrodes may be positioned between each layer of the separator formed by the folds. For example, as shown in FIG. 3, a resulting stack of alternating positive and negative electrodes is formed, with each electrode being separated by a segment of the folded separator.

### <Method for Manufacturing Electrode Assembly>

An exemplary embodiment of the present invention provides a method for manufacturing an electrode assembly including a first electrode, a separator, and a second electrode.

The method for manufacturing an electrode assembly according to an embodiment of the present invention includes a step of inductively heating the stack between a stacking process (which includes the steps of assembling the stack) and a heating and pressing step (which is a step of applying heat and pressure to the stack to bond the component electrodes and separator to each other). The method additionally includes a step of inductively heating an electrode tab portion of the inductively heated stack.

The heating and pressing step involves a lower plate on which an electrode assembly to be heated and pressed is placed and to which heat may be applied, and an upper plate associated with and positioned above the lower plate and to which heat may be applied. The lower plate and the upper plate may be pressing blocks configured as a pair.

In the heating and pressing step of heating and pressing the electrode assembly, electrodes located near the outermost sides of the stack (i.e., the uppermost and lowermost ends of the stack in the stacking direction) are in direct (or close) physical contact with the lower plate and the upper plate, and therefore can receive more heat and pressure than an electrode at a middle position of the stack. That is, in the heating and pressing step, the result is that electrodes in the stack may be heated to different temperatures depending on their positions along the stack, such that the electrodes and the separator have different adhesive forces between them depending on their positions within the stack. As a result, there may occur a problem in that the performance of the electrode assembly becomes non-uniform depending on position along the stack.

Accordingly, in the method for manufacturing an electrode assembly according to an embodiment of the present invention, more heat can be applied to a local region, particularly a central portion along the stacking direction, via the induction heating step. The heat applied to that local region may then diffuse throughout the electrode assembly. By heating and pressing the electrode assembly in the subsequent heating and pressing step in conjunction with (i.e., before, after, or concurrently) the induction heating step, the electrode assembly may desirably be more uniformly heated along the stacking direction.

In the above process, since a thickness of the electrode tab included in the stack is thinner than the electrode and the separator, a temperature of the electrode tab portion decreases faster than other portions after the induction heating step. As a result, even if the induction heating step and the heating and pressing step are performed, a problem may occur in which a region of the electrode assembly in the vicinity of the electrode tab is non-uniformly heated. The present embodiment further performs a step of inductively heating the electrode tab portion between the induction heating step and the heating and pressing step, whereby the electrode assembly may desirably be more uniformly heated as a whole.

As a result of the increased uniformity in heating, any deviation in air permeability of the separator, as well as any deviation in adhesive force between the separator and the electrodes, at different locations within the stack may be reduced, such that an electrode assembly with more uniform performance can be manufactured.

In an exemplary embodiment of the present invention, the stacking step may include supplying the first electrode to a stack table; supplying the second electrode to the stack table; and supplying the separator to the stack table.

In the present specification, “induction heating” refers to heating a target object by using an electromagnetic induction phenomenon. In this way, Joule heat is generated in the target object by the induced current generated in the target object by the electromagnetic induction phenomenon. Therefore, the induction heating is a heating method capable of locally heating a target object at a certain distance from a heating element. In contrast, a direct heating method involves heating a target object in direct (or close) contact with the target object (e.g., via some combination of conduction, radiation, and/or convection).

A coil may be used to perform the induction heating, which may be defined as an “induction heating coil”. The induction heating method has an advantage in that it is easy to control heat and time applied to a heating target. In addition, the induction heating method is capable of evenly-applied, non-contact heating, and therefore may not damage the heating target.

In the present specification, “induction heating step” may mean locally heating the stack by using an electromagnetic induction heating phenomenon. The locally heated stack may have electrodes arranged in the central portion of the stack. When the direct heating method is used, the uppermost or lowermost electrode(s) of the electrode assembly, which are closer to the applied heat, may be heated more than the central electrode of the electrode assembly. However, in a method for manufacturing an electrode assembly according to an exemplary embodiment of the present invention, the central portion of the electrode assembly is first selectively heated via an induction heating method, and then the electrode assembly may be heated by a direct heating method in a subsequent heating and pressing step, such that the electrode assembly may ultimately be heated more uniformly.

In the present specification, the “electrode tab induction heating step” uses the electromagnetic induction heating phenomenon, like the induction heating step, and can be distinguished from the induction heating step in that a heating target is the electrode tab portion included in the electrode of the stack. That is, the target to be locally heated may be one or more electrode tabs extending from the electrodes. Since the thickness of the electrode tab is relatively very thin, as compared with the thickness of each electrode and the separator, the temperature on the surface of the electrode tab may decrease the quickest after the induction heating step is stopped. For such reason, the temperature of the electrode tab portion may become relatively non-uniform leading up to the heating and pressing step. However, in the method for manufacturing an electrode assembly according to an exemplary embodiment of the present invention, the electrode tab(s) may be further heated via an electrode tab induction heating method after the induction heating step and before proceeding with the heating and pressing step, such that the electrode assembly may be more uniformly heated in the subsequent heating and pressing step.

In an exemplary embodiment of the present invention, in the electrode tab induction heating step, at least one of the first electrode tab and the second electrode tab may be inductively heated using an induction heating coil.

In an exemplary embodiment of the present invention, the induction heating coil may be in contact with or spaced from at least one of the first electrode tab and the second electrode tab by a predetermined distance. When the induction heating coil is in contact with the electrode tab (e.g., a distance between the electrode tab and the induction heating coil is 0 mm), the induction heating coil can transfer heat as much as possible, and therefore, it is possible to increase the temperature of the electrode tab even if induction heating is performed for a short time.

In addition, when the induction heating coil is spaced from the electrode tab by a predetermined distance, it is possible to increase the temperature of the electrode tab without damaging the electrode tab by heat generated from the induction heating coil.

In an exemplary embodiment of the present invention, the predetermined distance may be 15 mm or less. More specifically, in an exemplary embodiment of the present invention, the predetermined distance may be greater than 0 mm and equal to or less than 15 mm, preferably equal to or greater than 0.05 mm and equal to or less than 10 mm, and more preferably equal to or greater than 0.3 mm and equal to or less than 5 mm. When the above distance is satisfied, it is possible to inductively heat the electrode tab without damaging the electrode tab, as described above.

In an exemplary embodiment of the present invention, the electrode tab induction heating step may be performed for 1 second to 60 seconds, preferably 5 seconds to 40 seconds, and more preferably 10 seconds to 30 seconds. However, the electrode tab induction heating time may be selected, considering an induction heating temperature in the induction heating step, as well as a degree to which the electrode assembly is non-uniformly heated in the heating and pressing step.

In an exemplary embodiment of the present invention, in the electrode tab induction heating step, the electrode tab may be heated at a temperature of 40° C. or higher and 90° C. or lower, and preferably 50° C. or higher and 80° C. or lower. When the electrode tab is inductively heated within the temperature range described above, the electrode tab can be heated without being damaged.

In an exemplary embodiment of the present invention, in the induction heating step, a portion of the stack is inductively heated, and the heat diffuses to other portions of the stack so as to heat the entire stack.

In an exemplary embodiment of the present invention, in the induction heating step, a first electrode or second electrode arranged in a center of the stack may be inductively heated. In the heating and pressing step, a relatively small amount of heat may be applied to the first electrode or second electrode arranged in the center of the stack, as compared with a first electrode or second electrode arranged at the outermost ends of the stack. However, the heat may be first applied to the first electrode or second electrode arranged in the center of the stack through the induction heating step, and then the heating and pressing step may be subsequently performed, so that heat may be uniformly applied throughout the stack.

In the present specification, the induction heating may include induction heating for the entire surface of the stack, in addition to induction heating for only a partial region (local region) of the surface of the stack. However, even when only a partial region is inductively heated, an object of the present invention can be achieved. In addition, the induction heating can be distinguished from the heating and pressing in that no pressure may be applied to the stack during the induction heating.

In an exemplary embodiment of the present invention, the induction heating step may be performed for 1 second to 60 seconds, preferably 5 seconds to 40 seconds, and more preferably 10 seconds to 30 seconds. The induction heating time may be selected, considering a degree to which the electrode assembly is non-uniformly heated in the heating and pressing step.

In an exemplary embodiment of the present invention, the induction heating step may inductively heat the stack using an induction heating coil.

The method for manufacturing an electrode assembly according to an exemplary embodiment of the present invention may include a step of conveying the stack to the heating and pressing step after the stacking step. In the conveying step, the stack may be gripped with a gripper.

It is important to stabilize the stack so that the component electrodes and separator do not slide laterally with respect to each other before or during the heating and pressing that results in the electrodes and separators being bonded to each other. Thus, to provide that stability, the gripper may hold the stack by maintaining a grip on the stack during at least part of the heating and pressing step.

The method for manufacturing an electrode assembly according to an exemplary embodiment of the present invention may include inductively heating the stack while conveying the stack from the stack table to the heating and pressing unit. More specifically, in an exemplary embodiment of the present invention, the induction heating step may further include gripping the stack with a gripper including an induction heating coil and conveying the stack between the stacking step and the heating and pressing step. The induction heating step may be performed with the gripper during the conveying step.

More specifically, in an exemplary embodiment of the present invention, the induction heating step may include gripping the stack with a gripper including an induction heating coil; conveying the gripped stack to the heating and pressing step; and inductively heating the stack with the induction heating coil of the gripper while conveying the stack.

With the induction heating coil being built into or attached to the gripper, there is no need to provide a separate space for induction heating, thus making an electrode assembly manufacturing apparatus compact.

Meanwhile, in an exemplary embodiment of the present invention, the induction heating step may further include conveying the stack to an induction heating device including an induction heating coil between the stacking step and the heating and pressing step, and the induction heating step may be performed in the induction heating device. As long as the induction heating device can perform induction heating, any method commonly used in related fields may be used.

More specifically, in an exemplary embodiment of the present invention, the induction heating step may include gripping the stack with a gripper and conveying the gripped stack to an induction heating device including an induction heating coil; and inductively heating the stack in the induction heating device.

The induction heating coil may not be mounted inside or outside the gripper, but rather an induction heating device separate from the gripper may include the induction heating coil. When a separate induction heating device is used, the induction heating step can be performed even when a thickness of the stack including the electrodes and the separator becomes thick.

In addition, when the separate induction heating device is used as in the present embodiment, an electrode tab portion protruding from the electrode may be additionally heated by the induction heating device, and therefore, a temperature difference between the electrode tab and the electrode can be reduced.

In an exemplary embodiment of the present invention, in the induction heating step, the stack may be heated at a temperature of 40° C. or higher and 90° C. or lower, preferably 50° C. or higher and 80° C. or lower, and even more preferably 60° C. or higher and 80° C. or lower. It is believed that, ideally, the stack will be heated to a temperature of about 80° C., but that, during subsequent cooling (after the induction heating has stopped being applied), the temperature of the stack will not drop below about 60° C. before the pressing is applied to the stack in the later heating and pressing step. When the stack is inductively heated within the temperature range described above, the stack can desirably be heated without damaging the electrodes and the separator inside the stack.

In an exemplary embodiment of the present invention, the induction heating coil may be in contact with the stack or spaced from the stack by a predetermined distance.

When the induction heating coil is in contact with the stack (e.g., a distance between the stack and the induction heating coil is 0 mm), the induction heating coil can transfer heat as much as possible, and therefore, it is possible to increase the internal temperature of the stack even if induction heating is performed for a short time.

In addition, when the induction heating coil is spaced from the stack by a predetermined distance, it is possible to increase the internal temperature of the stack without damaging the stack by heat generated from the induction heating coil.

In an exemplary embodiment of the present invention, the predetermined distance may be 15 mm or less. More specifically, in an exemplary embodiment of the present invention, the predetermined distance may be greater than 0 mm and equal to or less than 15 mm, preferably equal to or greater than 0.05 mm and equal to or less than 10 mm, and more preferably equal to or greater than 0.3 mm and equal to or less than 5 mm. When the above distance is satisfied, it is possible to inductively heat the electrode without damaging the stack, as described above.

The method for manufacturing an electrode assembly according to an exemplary embodiment of the present invention may further include, before the heating and pressing step, a step of removing the induction heating unit from a line along which the electrode assembly is being conveyed. In this manner, physical collision between the induction heating unit and the heating and pressing unit can be prevented.

In addition, physical collision between the gripper and the heating and pressing unit can also be prevented by performing a first heating and pressing step and a second heating and pressing step, described later.

The method for manufacturing an electrode assembly according to an exemplary embodiment of the present invention may further include a standby step of allowing the stack to stand by in an atmospheric state for a certain period of time between the induction heating step and the heating and pressing step. The atmospheric state means that after the induction heating step, induction heating is stopped for a certain period of time to wait for heat applied to the stack by the induction heating to diffuse throughout the stack.

Through the standby step, heat transferred to a partial region of the stack may be transferred to the entire region of the stack. In this way, by intentionally stopping the induction heating of the stack for a certain period of time before proceeding with the heating and pressing step, the heat transferred to the stack by the induction heating may diffuse uniformly throughout the stack.

Thereafter, by heating and pressing the stack through the subsequent heating and pressing step, uniformity in thickness of the electrode can be increased throughout the electrode assembly.

In an exemplary embodiment of the present invention, the standby step may be performed for 3 seconds or longer and 60 seconds or shorter, preferably 5 seconds or longer and 45 seconds or shorter, and more preferably 10 seconds or longer and 40 seconds or shorter.

When the time range described above is satisfied, it is possible to provide a time during which heat transferred to a partial region of the electrode inside the stack by the induction heating can distribute evenly throughout the stack. That is, if the standby step is performed for less than 3 seconds, the heat transferred to a partial region of the stack may be difficult to transfer throughout the electrode. On the other hand, if the standby step is performed for longer than 60 seconds, the temperature of the electrode raised by the transferred heat may be decreased, and therefore, there may be a problem in that the effect of induction heating is reduced.

The standby time may be changed according to the heating time and heating temperature range of the stack in the subsequent heating and pressing step.

In an exemplary embodiment of the present invention, for the step of manufacturing a stack in which the first electrode and the second electrode are alternately arranged between folds of the folded separator, any technology that is commonly used in a related field may be used. For example, processes of stacking a first electrode on the stack table, covering the first electrode with a separator, stacking a second electrode on an upper surface of the separator, folding the separator to cover the second electrode, and stacking a first electrode on the upper surface of the separator may be repeated. This is referred to as a zigzag stacking method in the present exemplary embodiment. In this case, for the process of moving the separator while covering the first electrode or the second electrode placed on the separator, a method in which the stack table moves left and right, a method in which the separator moves left and right, a method in which the stack table rotates, and the like may be applied.

In the zigzag stacking method, a holding mechanism may grip the stack to maintain alignment of the stack during the process of stacking the first electrode, the second electrode, and the separator.

In the present specification, the “holding mechanism” is a tool for gripping a stack placed on a stack table in order to stack the first electrode or the second electrode in the zigzag stacking method, and is different from the gripper for gripping the stack in the heating and pressing step.

In an exemplary embodiment of the present invention, the separator may be supplied in a form of an elongated separator sheet. That is, the separator to be additionally supplied may be supplied in a continuous form. In addition, the “upper surface” may refer to a surface opposite to a surface of the stack table on which a separator or electrode is placed.

The method for manufacturing an electrode assembly according to an exemplary embodiment of the present invention may include a heating and pressing step of heating and pressing the stack inductively heated as described above. In the heating and pressing step, the stack may be heated while being pressed in a direction of the stacking axis. In addition, the heating and pressing step may be performed by a heating and pressing unit described later.

Further, in an exemplary embodiment of the present invention, the heating and pressing step may include moving the stack between a pair of pressing blocks including press heaters; surface-pressing the stack by mutually moving the pair of pressing blocks in the direction of the stacking axis; and heating the stack.

The pair of pressing blocks may include a lower plate and an upper plate facing the lower plate.

Further, in another exemplary embodiment of the present invention, the heating and pressing step may include moving the stack between a pair of pressing blocks; surface-pressing the stack by moving the pair of pressing blocks in the direction of the stacking axis; and heating the stack by a separately provided press heater.

The press heater may be included in the pressing block or may be provided as a separate configuration.

The method for manufacturing an electrode assembly according to an exemplary embodiment of the present invention may further include a step of releasing gripping of the gripper before the heating and pressing step. That is, the step of releasing gripping of the gripper may include stopping pressing on the upper surface of the stack by the gripper; and spacing the gripper from the stack.

The step of moving the stack between the pair of pressing blocks including press heaters in the heating and pressing step may include not only a case where only the stack itself is moved but also a case where the stack is moved together with the stack table while the stack is positioned on the stack table. In such case, a target to be heated and pressed by the pair of pressing blocks and the press heaters may refer to the stack and the stack table.

In an exemplary embodiment of the present invention, in the heating and pressing step, the stack may be heated and pressed for 5 seconds to 60 seconds under a temperature condition of 50° C. to 90° C. and a pressure condition of 0.5 Mpa to 6.0 Mpa. More preferably, the stack may be heated and pressed for 5 seconds to 30 seconds under a temperature condition of 65° C. to 90° C. and a pressure condition of 1.0 Mpa to 6.0 Mpa. More preferably, the stack may be heated and pressed for 7 seconds to 25 seconds under a temperature condition of 65° C. to 85° C. and a pressure condition of 3 Mpa to 5.5 Mpa.

When heating and pressing are performed while satisfying the above conditions, the adhesive forces between the first electrode and the separator and between the separator and the second electrode can be improved without damaging the first electrode, the separator, and the second electrode. As a result, the performance of the electrode assembly can be improved.

In an exemplary embodiment of the present invention, the heating and pressing step are not performed while the induction heating step is performed.

In an exemplary embodiment of the present invention, the induction heating step may include measuring a temperature distribution on a surface of the stack; setting an induction heating temperature for the stack according to the measured temperature distribution; and inductively heating the stack based on the set induction heating temperature. That is, by adjusting the induction heating temperature of the stack according to the measured temperature distribution of the upper surface of the stack, it is possible to inductively heat the electrode in an efficient manner without using unnecessary energy.

In an exemplary embodiment of the present invention, the electrode tab induction heating step may be performed between the induction heating step and the heating and pressing step. That is, the electrode tab induction heating step proceeds after the induction heating step. This is because even though the induction heating step is performed, additional heating may be required due to the rapid temperature change of the electrode tab portion. Since a goal is to heat the stack including the electrode tabs to a uniform temperature in the heating and pressing step, the electrode tab induction heating step may be performed before the heating and pressing step.

A method for manufacturing an electrode assembly according to an exemplary embodiment of the present invention may sequentially proceed from the induction heating step; the electrode tab induction heating step to the heating and pressing step. In addition, the method may further include the standby step between the induction heating step and the electrode tab induction heating step.

In yet another alternative embodiment, one or both of the induction heating steps (i.e., the induction heating step and/or the electrode tab induction heating step) can be combined with the heating and pressing step. For example, the same unit can be used to apply the induction heating and also the heating and pressing. Moreover, all of those process could be performed simultaneously (by that single unit or by multiple units).

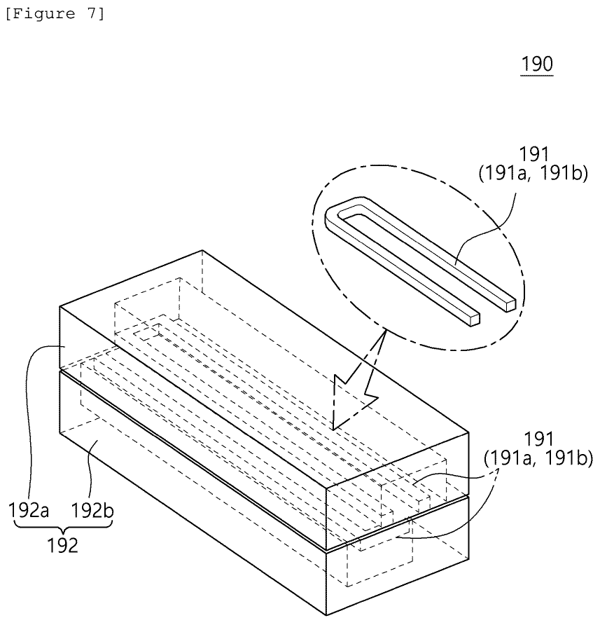

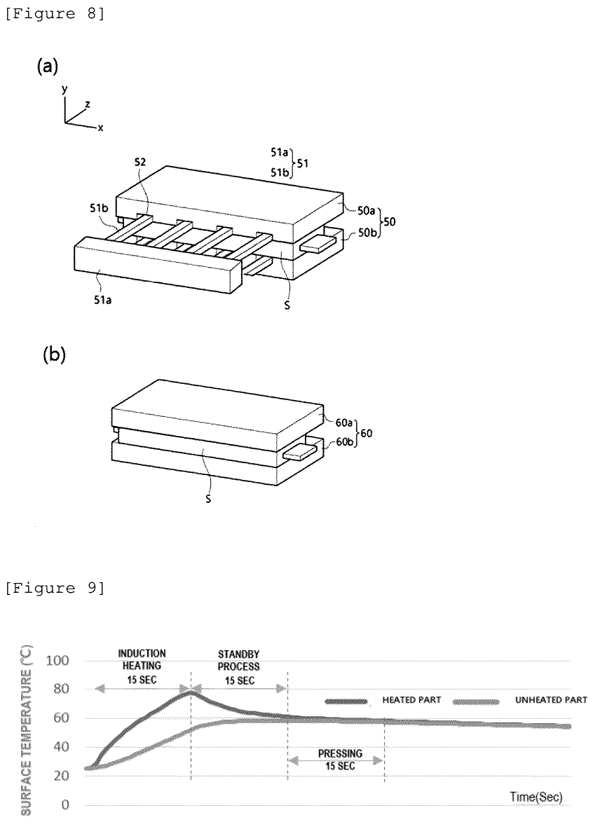

As an example, a combined unit might include upper and lower pressing blocks similar to the pressing blocks 60a and 60b shown in part (b) of FIG. 8. Like those pressing blocks 60a, 60b, the upper and lower pressing blocks of the combined unit may be configured to move towards one another to apply pressure to the stack S positioned between them. Moreover, such upper and lower blocks may be heated (e.g., by internal resistance heaters) so as to apply direct heating to the upper and/or lower surfaces of the stack S (e.g., by applying conductive heating to those outer surfaces). In addition, each of the upper and lower blocks of the combined unit may include one or more induction heating coils 191 like those shown in FIG. 7. In that manner, the upper and lower heating blocks may also apply inductive heating to the stack S. As discussed above, such inductive heating may particularly target a central portion of the stack S along the stacking direction.

The above example may be further supplemented by an electrode tab induction heating unit 193 like that illustrated in FIG. 6 for applying induction heating to one or more electrode tabs 10a extending from the stack. Such induction heating unit 193 can be a separate unit from the combined unit that applies induction heating as well as heating and pressing, as discussed above, or the induction heating unit 193 can be part of an extension extending upward and/or downward from the opposing heating blocks of the combined unit.

Although the inductive heating and the direct heating steps may be applied sequentially (including with one or more optional standby steps between them), the inductive and direct heating steps may alternatively all be applied concurrently. That way, uniform heating of the stack S may still be obtained by the three applied forms of heating targeting different portions of the electrode stack at substantially the same time. That is, the direct heating method may preferentially heat the upper and lower surfaces of the stack S, while the inductive heating steps may preferentially heat the central portion of the stack S and one or more of the electrode tabs.

### <Electrode Assembly Manufacturing Apparatus>

An exemplary embodiment of the present invention provides an apparatus for manufacturing an electrode assembly (electrode assembly manufacturing apparatus), where the electrode assembly includes a first electrode, a separator and a second electrode.

For reference, a semi-finished product state in which the first electrode, the separator, and the second electrode are repeatedly stacked is referred to as a stack, after which a separator winding process is performed on the semi-finished stack so as to produce a single, unified component classified as an electrode assembly. At least one of the first electrodes of the stack may include a first electrode tab, and at least one of the second electrodes of the stack may include a second electrode tab, which electrode tabs are part of the finally manufactured electrode assembly.

The electrode assembly manufacturing apparatus includes an induction heating unit and an electrode tab induction heating unit. The induction heating unit of the electrode assembly manufacturing apparatus of the present embodiment performs the above-described induction heating step, and the electrode tab induction heating unit performs the above-described electrode tab induction heating step. That is, when the electrode assembly manufacturing apparatus according to the present embodiment is used, the stack including the first electrode, the separator, and the second electrode is uniformly heated in the process of performing the heating and pressing step by the heating and pressing unit, so that uniform adhesive force can be obtained between the respective layers in the stack. In addition, as a result, any deviations in the air permeability and/or thickness of the separator along its length are reduced, so that an electrode assembly with uniform performance can be manufactured while reducing a volume of the electrode assembly. In addition, an electrode assembly with an increased energy density per unit volume can be manufactured.

The electrode assembly manufacturing apparatus according to an embodiment of the present invention may further include a separator supply unit configured to supply the separator to the stack table; a first electrode supply unit configured to supply the first electrode to the stack table; and a second electrode supply unit configured to supply the second electrode to the stack table.

In an exemplary embodiment of the present invention, the induction heating unit may be associated with a gripper that is configured to grip the stack in order to convey the stack to the heating and pressing unit. The gripper may include an induction heating coil. As described above, the induction heating coil may be built into the gripper or may be installed outside the gripper. When the gripper serves as an induction heating unit, a process space for installing the induction heating unit can be saved. In addition, a process time can also be shortened because induction heating can be performed while conveying the stack. The gripper may perform a function of gripping the stack while conveying the stack from the stack table to the heating and pressing unit.

In an exemplary embodiment of the present invention, the induction heating unit may be a separate component from the gripper that conveys the stack. That is, the induction heating unit may include a first induction heating device including an induction heating coil; and a first device moving unit configured to move the first induction heating device to a surface of the stack. When the first device moving unit moves the first induction heating device to an appropriate distance from the stack, the first induction heating device may inductively heat the stack. When the induction heating on the stack is completed, the first device moving unit may separate the first induction heating device from the stack.

In this case, as described above, there is an advantage in that it is easy to apply even if the thickness of the stack is thick, and there is an advantage in that it can be used even when inductively heating the electrode tab.

In the present specification, “unit” means an interface that performs a specific function within the electrode assembly manufacturing apparatus.

The induction heating coil of the electrode assembly manufacturing apparatus according to an exemplary embodiment of the present invention may be in contact with the stack or spaced from the stack by a predetermined distance. In this case, the predetermined distance may be 15 mm or less, more specifically, greater than 0 mm and equal to or less than 15 mm, preferably equal to or greater than 0.05 mm and equal to or less than 10 mm, and more preferably equal to or greater than 0.3 mm and equal to or less than 5 mm.

The advantages that are achieved when the induction heating coil is in contact with the stack and when the induction heating coil is spaced from the stack by a predetermined distance are as described in the method for manufacturing an electrode assembly.

In an exemplary embodiment of the present invention, the induction heating unit may include an induction heating coil and an induction heating plate.

In addition, the induction heating coil may be included inside an induction heating plate that includes a non-conductive material. The induction heating plate may include an alternating current generator for providing alternating current to the induction heating coil and may serve to protect the induction heating coil. The use of a non-conductive material as a material of the induction heating plate is to prevent an induced current by the induction heating coil from being generated also in the induction heating plate.

The induction heating plate may comprise a mold made of a non-conductive material. The non-conductive material may be epoxy, but is not limited thereto.

In addition, the induction heating coil and the induction heating plate may constitute one unified component.

The induction heating unit may include an alternating current generator, but is not limited thereto, and any means capable of generating an electromagnetic induction phenomenon for the induction heating coil may be utilized.

The electrode assembly manufacturing apparatus according to an exemplary embodiment of the present invention may further include a first control unit configured to receive measurements of a temperature distribution on a surface of the stack, to set or adjust an induction heating temperature for the stack according to the measured temperature distribution, and to determine whether to stop induction heating for the stack based on the induction heating temperature and an induction heating time for the stack.

In addition, the first control unit may also be configured to set or adjust an induction heating time for the stack.

That is, a condition for performing the induction heating step and a condition for performing the standby step can be set by the first control unit. For each condition, the contents described in the method for manufacturing an electrode assembly may be applied.

In an exemplary embodiment of the present invention, the electrode tab induction heating unit may include a second induction heating device including an induction heating coil, and the electrode tab induction heating unit may also include a second device moving unit configured to move the second induction heating device to the first electrode tab or second electrode tab portion. When the second device moving unit moves the second induction heating device to an appropriate distance from the electrode tab, the second induction heating device may inductively heat the electrode tab. When the induction heating on the electrode tab is completed, the second device moving unit may separate the second induction heating device from the electrode tab. This process may be performed through the second control unit that performs a function of controlling an operation of the electrode tab induction heating unit according to the condition of the above-described electrode tab induction heating step.

In an exemplary embodiment of the present invention, the induction heating coil may be in contact with or spaced from at least one of the first electrode tab and the second electrode tab by a predetermined distance. In this case, the predetermined distance may be 15 mm or less, more specifically: greater than 0 mm and equal to or less than 15 mm. Even more preferably, the predetermined distance may be equal to or greater than 0.05 mm and equal to or less than 10 mm. Even more preferably still, the predetermined distance may be equal to or greater than 0.3 mm and equal to or less than 5 mm.

The advantages that are achieved when the induction heating coil is in contact with the electrode tab and when the induction heating coil is spaced from the electrode tab by a predetermined distance are as described in the method for manufacturing an electrode assembly.

In an exemplary embodiment of the present invention, the electrode tab induction heating unit may include an induction heating coil and an induction heating plate. The description of the induction heating coil and the induction heating plate of the induction heating unit may be applied to the description of the induction heating coil and the induction heating plate of the electrode tab induction heating unit. However, some shapes and sizes may be different, depending on the size difference and location of the heating target.

In an exemplary embodiment of the present invention, the heating and pressing unit may include a pair of pressing blocks and may be configured to surface-press the stack while moving the pair of pressing blocks in directions towards one another.

The heating and pressing unit may include a pair of pressing blocks and a press heater for heating the pressing blocks. While the press heater heats the pressing blocks, the pair of pressing blocks move in directions towards one another, so that the stack placed between the pressing blocks can be surface-pressed. For example, the pair of pressing blocks may include press heaters therein.

In another exemplary embodiment of the present invention, the heating and pressing unit may include two separate heating and pressing units. That is, the heating and pressing unit may include a first heating and pressing unit and a second heating and pressing unit.

Referring to FIG. 7, the first heating and pressing unit may include a pair of first pressing blocks. Pressing surfaces of the pair of first pressing blocks may include grooves corresponding to the structure of the gripper so as to press the stack while the gripper grips the stack. The pressing surfaces other than the grooves may be planes. The second heating and pressing unit may include a pair of second pressing blocks. Pressing surfaces of the pair of second pressing blocks may be provided as planes. That is, when the stack is placed on the press surfaces of the pressing blocks, the second pressing blocks may move towards one another to heat and press the stack.

When the heating and pressing unit is divided into two units as described above, it is possible to prevent loss of adhesive force between respective layers inside the stack due to cooling while the heated stack is conveyed.

Conditions for heating and pressing the stack by the heating and pressing unit may be the same as those of the heating and pressing step described above.

The electrode assembly manufacturing apparatus according to an exemplary embodiment of the present invention may be configured such that the induction heating unit, the electrode tab induction heating unit, and the heating and pressing unit are sequentially operated. That is, as described above, the apparatus may operate such that the electrode tab induction heating step can be performed between the induction heating step and the heating and pressing step.

Meanwhile, in an exemplary embodiment of the present invention, the electrode assembly may have a rated capacity of 50 Ah to 200 Ah, preferably 50 Ah to 150 Ah, and more preferably 60 Ah to 140 Ah.

The electrode assembly may have a ratio of a full length to a full width of 5 to 10, preferably 5 to 8. Specifically, the electrode assembly may have a full length of 400 mm to 600 mm, a full width of 50 mm to 150 mm, preferably a full length of 500 mm to 600 mm, and a full width of 50 mm to 100 mm.

An exemplary embodiment of the present invention includes a first pressing unit including induction heating and a second pressing unit for heating and pressing the inductively heated electrode assembly after the stack is assembled on the stack table, to complete the electrode assembly. In particular, in the case of a large-sized electrode assembly that is heated by a direct contact method, a severe temperature deviation may occur depending on a position inside the electrode assembly, particularly between the outermost ends of the electrode assembly and the central portion of the electrode assembly. However, when the exemplary embodiment of the present invention is applied to a large-sized electrode assembly, it can lead to advantages in uniformly heating the entire electrode assembly, regardless of the location within the electrode assembly, even if the thickness of the electrode assembly is thick.

In an exemplary embodiment of the present invention, the stack table may include a table body on which the stack is placed and a drive unit configured to drive the table body. The table body may include a stack table heater capable of heating the stack to a predetermined temperature when the stack is placed on the table body.

In an exemplary embodiment of the present invention, the first electrode supply unit may include at least one of a first electrode seating table, a first electrode roll, a first cutter, a first conveyor belt, and a first electrode supply head.

In addition, the first electrode seating table may include a first electrode heater for heating the first electrode placed on the first electrode seating table to a predetermined temperature.

In an exemplary embodiment of the present invention, the second electrode supply unit may include at least one of a second electrode seating table, a second electrode roll, a second cutter, a second conveyor belt, and a second electrode supply head.

In addition, the second electrode seating table may include a second electrode heater for heating the second electrode placed on the second electrode seating table to a predetermined temperature.

In an exemplary embodiment of the present invention, a first electrode stacking unit may include a first suction head that grasps the first electrode seated on the first electrode seating table via vacuum suction. The first electrode may be moved from the first electrode seating table to the stack table by the first electrode stacking unit.

A second electrode stacking unit may include a second suction head that grasps the second electrode seated on the second electrode seating table via vacuum suction. The second electrode may be moved from the second electrode seating table to the stack table by the second electrode stacking unit.

In an exemplary embodiment of the present invention, the first electrode may be a positive electrode, and the second electrode may be a negative electrode.

In another exemplary embodiment of the present invention, the first electrode may be a negative electrode, and the second electrode may be a positive electrode.

In an exemplary embodiment of the present invention, for current collectors used for a positive electrode and a negative electrode, an active material and a conductive material may be included, and active materials and conductive materials known in the art can be used without limitation. Likewise, for methods for manufacturing the positive electrode and the negative electrode, methods known in the related art can be used without limitation.

In an exemplary embodiment of the present invention, for the separator, separator materials known in the art can be used without limitation, and, likewise, for a method for manufacturing a separator, methods known in the related art can be used without limitation. However, in an exemplary embodiment of the present invention, the separator may include a porous polymer substrate and an organic/inorganic composite porous coating layer formed on at least one surface of the polymer substrate, and the organic/inorganic composite porous coating layer may include particulate binder resins and inorganic particles.

In an exemplary embodiment of the present invention, the particulate binder resin may include at least one selected from the group consisting of a fluorine-based polymer, an acrylic polymer particle, and a hybrid polymer particle of an acrylic polymer particle, and an acrylic polymer.

In an exemplary embodiment of the present invention, the fluorine-based polymer may be a homopolymer of vinylidene fluoride, a copolymer of vinylidene fluoride, and another polymerizable monomer, or a mixture of two or more thereof.

In an exemplary embodiment of the present invention, the inorganic particle may be Al₂O₃, but is not limited thereto.

Since the organic/inorganic composite porous coating layer is included, an electrode assembly having increased adhesive force between the electrode and the separator can be manufactured by applying the induction heating step and the heating and pressing step described in the electrode assembly manufacturing method and/or the electrode assembly manufacturing apparatus.

Hereinafter, an electrode assembly manufacturing apparatus and an electrode assembly manufacturing method according to an exemplary embodiment of the present invention will be described in more detail. The following description assumes that the electrode assembly of the present invention is zigzag stacked, as depicted in FIG. 3.

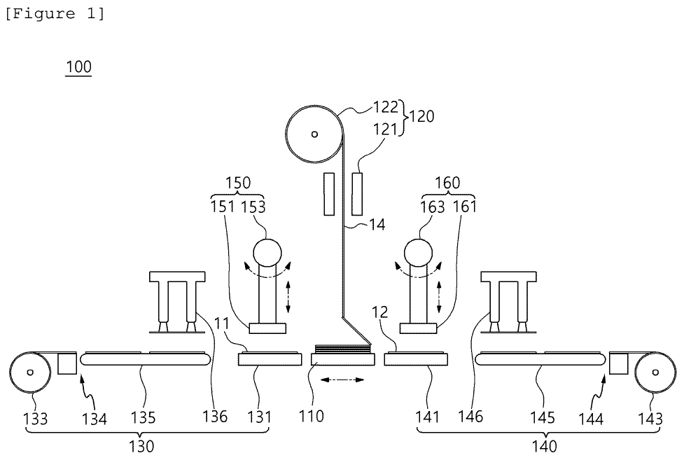

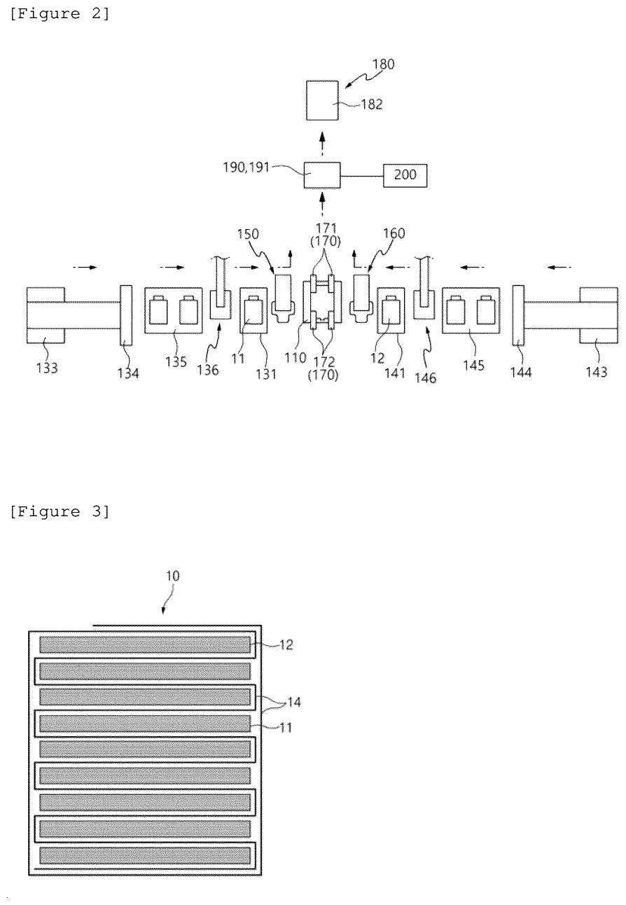

FIG. 1 is a side elevation view schematically illustrating an electrode assembly manufacturing apparatus and its process flow according to an exemplary embodiment of the present invention, and FIG. 2 is a top plan view illustrating the electrode assembly manufacturing apparatus and its process flow according to the exemplary embodiment. For convenience, in FIG. 1, a holding mechanism 170, a heating and pressing unit 180, and an induction heating unit 190 (all shown in FIG. 2) are omitted, and in FIG. 2, a separator supply unit 120 (shown in FIG. 1) is omitted.

Referring to FIGS. 1 to 3, an electrode assembly manufacturing apparatus 100 according to an exemplary embodiment of the present invention includes a separator supply unit 120 that supplies a separator 14 to a stack table 110, a first electrode supply unit 130 that supplies a first electrode 11 to the stack table 110, and a second electrode supply unit 140 that supplies a second electrode 12 to the stack table 110. The separator 14, the first electrode 11, and the second electrode 12 may be each supplied to the stack table 110 while being heated in the separator supply unit 120, the first electrode supply unit 130, and the second electrode supply unit 140, respectively.

In addition, the electrode assembly manufacturing apparatus 100 according to an exemplary embodiment of the present invention includes a first electrode stacking unit 150 that stacks the first electrode 11 supplied by the first electrode supply unit 130 on the stack table 110, and a second electrode stacking unit 160 that stacks the second electrode 12 supplied by the second electrode supply unit 140 on the stack table 110. In this case, the separator 14 supplied by the separator supply unit 120 is stacked in a zigzag form while alternately being fed to the left side and the right side of the stacking axis. In this case, either one of the first electrode 11 and the second electrode 12 is alternately inserted into spaces between opposing layers of the separator 14 created by each successive fold. As a result, a stack in which the first electrode 11, the separator 14, the second electrode 12, and the separator 14 are repeatedly stacked is assembled on the stack table 110.

The separator supply unit 120 may include a separator heating unit 121 and a separator roll 122. The separator heating unit 121 may be selectively operated.

The first electrode supply unit 130 may include a first electrode seating table 131, a first electrode heater, a first electrode roll 133, a first cutter 134, a first conveyor belt 135, and a first electrode supply head 136. The first electrode heater may be selectively operated.

In addition, the second electrode supply unit 140 may include a second electrode seating table 141, a second electrode heater, a second electrode roll 143, a second cutter 144, a second conveyor belt 145, and a second electrode supply head 146. The second electrode heater may be selectively operated.

The first electrode stacking unit 150 stacks the first electrode 11 on the stack table 110. In this case, the first electrode stacking unit 150 may include a first suction head 151, a first head heater (not shown), and a first moving unit 153. In addition, the second electrode stacking unit 160 stacks the second electrode 12 on the stack table 110. The second electrode stacking unit 160 may include a second suction head 161, a second head heater (not shown), and a second moving unit 163.

The first electrode stacking unit 150 and the second electrode stacking unit 160 may further include heaters (not shown) for preheating the first electrode and the second electrode according to circumstances.

In addition, the electrode assembly manufacturing apparatus 100 according to an exemplary embodiment of the present invention may further include a holding mechanism 170 for securing the first electrode 11 and the second electrode 12 when they are stacked on the stack table 110. Further, the electrode assembly manufacturing apparatus 100 according to an exemplary embodiment of the present invention includes a heating and pressing unit 180 that heats and presses the stack placed on the stack table 110 to bond the first electrode 11, the separator 14, and the second electrode 12 to one another.

In addition, the electrode assembly manufacturing apparatus 100 according to an exemplary embodiment of the present invention further includes an induction heating unit 190 that inductively heats the stack to transfer heat to the electrodes in the stack. In addition, a control unit (schematically represented by unit 200) for controlling, for example, whether to actuate the induction heating unit 190 may be further included. Through this, it is possible to finally manufacture an electrode assembly 10 as shown in FIG. 3.

FIG. 3 is a cross-sectional side elevation view illustratively showing an electrode assembly manufactured by an electrode assembly manufacturing apparatus and an electrode assembly manufacturing method according to an exemplary embodiment of the present invention.

Referring to FIG. 3, the electrode assembly 10 may have a stacked form including a separator 14 folded and stacked in a zigzag form, along with first electrodes 11 and second electrodes 12 alternately inserted into spaces between folds of the separator.

In this case, the electrode assembly 10 may also be provided in such a form that the separator 14 surrounds the outermost perimeter of the stack. However, it should be noted that the configuration of the electrode assembly 10 is not limited to the example of FIG. 3.

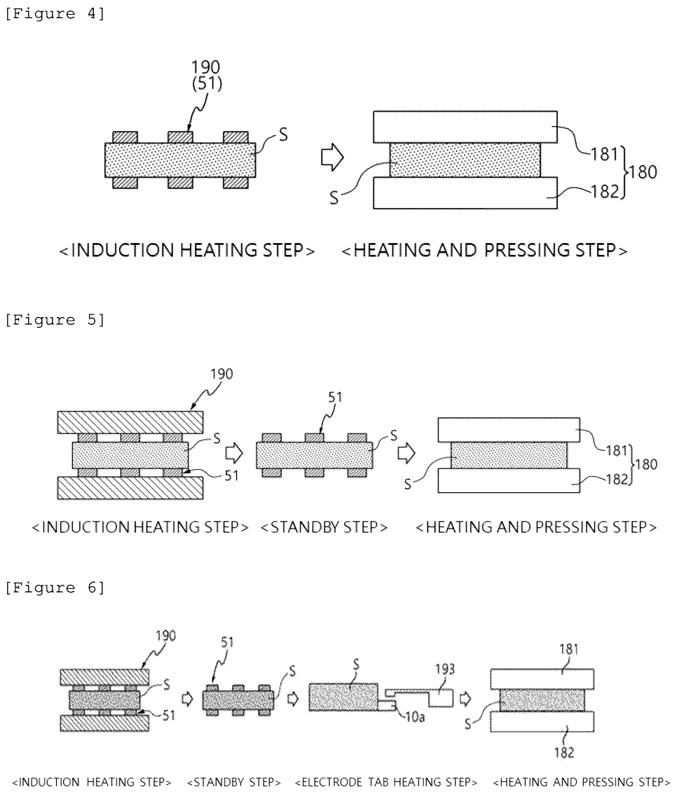

FIGS. 4 and 5 are views schematically showing an operation process of the induction heating unit according to an exemplary embodiment of the present invention.

Specifically, FIG. 4 shows a case where the induction heating unit 190 is part of a gripper 51. The gripper 510 may include an induction heating coil (not shown). The gripper 51 may perform induction heating on the stack S while gripping the stack S. While performing induction heating by the gripper 51, the stack S may be conveyed to the heating and pressing unit 180. In the heating and pressing unit 180, the stack S may be heated and pressed. In this case, before heating and pressing the stack S in the heating and pressing unit 180, a standby process (step) of stopping induction heating on the stack S and causing the stack to stand by for a certain period of time may be performed. In this case, a condition (such as the length of time) of the standby process may be set or adjusted by a control unit 200.

FIG. 5 shows another exemplary embodiment of the induction heating unit, illustrating that the stack S is inductively heated using the induction heating device 190 provided separately from the gripper 51. In this case, the stack S is inductively heated after being moved to the induction heating device. When the induction heating is completed, the stack S may be heated and pressed in the heating and pressing unit 180 as in FIG. 4. In this case, before heating and pressing the stack S in the heating and pressing unit 180, a standby process (step) of stopping induction heating on the inductively heated stack S and causing the stack to stand by for a certain period of time may be performed. In this case, a condition of the standby process may likewise be controlled by the control unit 200. As shown in FIG. 5, the standby process may be performed after the stack S is moved out of the induction heating unit 190 and while the stack S is gripped by the gripper 51.

FIG. 7 illustratively shows an induction heating unit according to an exemplary embodiment of the present invention. Referring to FIG. 7, the induction heating unit 190 may include an induction heating coil 191 and an induction heating plate 192. More specifically, induction heating coils 191a and 191b may be built into induction heating plates 192a and 192b, respectively. The induction heating coil 190 may have a U-shape. The induction heating coils 191a and 191b may face each other. The specific arrangement of the induction heating coil 191 may be as shown in FIG. 7, but is not limited thereto.

When alternating current is applied to the induction heating coil 191, induced current can be generated in the metallic electrodes in the electrode assembly, so the electrodes are heated by the induced current. Therefore, the induction heating can be generated so as to target one or more electrodes arranged in specific regions of the electrode assembly.

In the present embodiment, the induction heating is performed in advance before the heating and pressing step, targeting electrodes arranged at the central portion of the electrode assembly, which are not particularly well heated in the heating and pressing step.

FIG. 6 is a diagram schematically illustrating an operation process of an electrode tab induction heating unit according to an exemplary embodiment of the present invention. FIG. 6 shows, as an exemplary embodiment, that the stack S is inductively heated using the induction heating device 190 provided separately from the gripper 51. As described in FIG. 5, the induction heating step, the standby step, and the heating and pressing step may be performed on the stack S. In this case, the first electrode tab 10a portion may be inductively heated by the electrode tab induction heating unit 193 between the standby step and the heating and pressing step. In that manner, the temperature of the electrode tab portion, which may have been reduced, can be raised, so that the stack S can be pressed at a uniform temperature in the heating and pressing step. A plurality of the first electrode tabs may be included in the stack. In addition, the stack S may include a second electrode tab (not shown), and induction heating on the second electrode tab may be applied in the same method as induction heating on the first electrode tab. A plurality of the second electrode tabs may also be included in the stack. The conditions described above may be applied to the conditions of each step.

FIG. 8 shows a configuration of the heating and pressing unit, and particularly shows a case where the heating and pressing unit 50 includes a first heating and pressing unit 50 and a second heating and pressing unit 60.

Part (a) of FIG. 8 is a perspective view showing the first heating and pressing unit 50, and part (b) of FIG. 8 is a perspective view showing the second heating and pressing unit 60.

Referring to part (a) of FIG. 8, the first heating and pressing unit 50 may heat and press the stack S in a state where the stack S is secured by the gripper 51. The first heating and pressing unit 50 may include a pair of first pressing blocks 50a and 50b. In the pair of first pressing blocks 50a and 50b, pressing surfaces for pressing are all planes except for one or more grooves corresponding to the structure of a fixing part 51b of the gripper 51. As shown in part (a) of FIG. 8, the fixing part 51b of the gripper 51 may include two opposed contact parts, each of which may comprise an array of spaced apart contact members defined by, for example, generally parallel rods, columns, or plates spaced apart from one another in the length (x) direction and extending across the stack S in the width (z) direction. The array of the first contact part may be arranged to come into contact with the upper surface of the stack S, and the array of the second contact part may be arranged to come into contact with the lower surface of the stack S.

The gripper 51 may include a main body 51a corresponding to a length (x) and height (y) of the stack S or greater than the length (x) and height (y) of the stack S, and a fixing part 51b that protrudes from the main body 51a and holds the stack S. Here, the length (x) of the stack S means the longest part of the distance from one end to the other end of the stack S, the height (y) means a distance of the stack S in the stacking direction, and the width (z) may mean a distance horizontally traversing an upper surface of the stack S.

The fixing part 51b can be positioned along the height direction of the main body 51a such that the fixing part 51b can contact upper and lower surfaces of the stack S to securely grip the stack S.

Thereafter, the pair of first pressing blocks 50a and 50b move in directions towards one another to heat and press the stack S. The electrodes and separator inside the electrode assembly become stably bonded through the heating and pressing.

The first heating and pressing unit 50 may be a component that counteracts any cooling in the electrode assembly while the inductively heated electrode assembly moves, and thus the first heating and pressing unit may be optionally provided. That is, the first heating and pressing unit may be omitted in some cases.

Referring to art (b) of FIG. 8, the second heating and pressing unit 60 may finally heat and press the stack S that has been primarily heated and pressed by the first heating and pressing unit 50. The second heating and pressing unit 60 includes a pair of second pressing blocks 60a and 60b, and the pair of pressing blocks 61 and 62 may be moved in directions towards one another to surface-press the stack S. In addition, in the pair of second pressing blocks 60a and 60b included in the second heating and pressing unit 60, pressing surfaces for pressing in contact with the stack S may all be provided as planes.

The description of the electrode assembly manufacturing method according to the present invention may also be applied to the electrode assembly manufacturing apparatus according to the present invention, and vice versa.

### <Electrode Assembly>

In the present specification, the “outermost ends of the electrode assembly” means the uppermost position or the lowermost position in the stacking direction of the stack.

In addition, in the present specification, the “middle of the electrode assembly” means a position located between the uppermost position and the lowermost position in the stacking direction of the stacked stack.

An exemplary embodiment of the present invention provides an electrode assembly including a first electrode, a separator, and a second electrode manufactured according to the electrode assembly manufacturing method and/or the electrode assembly manufacturing apparatus according to the embodiments of the present invention. That is, the electrode assembly may be an electrode assembly stacked in a zigzag stacking method.

However, the electrode assembly may also have a laminating and folding (L&F) or jelly-roll structure, in which electrodes and a separator are wound, or a stacking and laminating (S&L) or stack-type structure, in which electrodes and a separator are sequentially stacked. That is, the present invention is applicable to various types of electrode assemblies because the present invention adds the process of heating and pressing the electrode assembly in order to improve the adhesive force between the electrodes and the separator(s) in the electrode assembly after completing the assembly of the electrode assembly.

In an exemplary embodiment of the present invention, since the electrode assembly is compressed while being heated, the energy density per unit volume may be increased. That is, since the electrode assembly is heated and pressed, the volume of the electrode assembly is reduced, as compared with a case where the electrodes and the separator are simply stacked and then packaged.

In particular, the volume reduction of the electrode assembly may be due to the separator. That is, in the present specification, the separator may be compressed after zigzag stacking and application of heating and pressing, as compared with the separator before such processes.

In an exemplary embodiment of the present invention, a compression rate of the separator located at the outermost ends of the electrode assembly in the stacking direction is greater than a compression rate of the separator towards the middle of the electrode assembly in the stacking direction. Moreover, a difference in those compression rates is 3% p (percentage point), preferably 2% p, and more preferably 1.5% p. Such difference in compression rates is determined by: (1) calculating the compression rate in percentage points of the separator located at any one of the outermost ends of the electrode assembly in the stacking direction; (2) calculating the compression rate in percentage points of the separator located at the middle of the electrode assembly in the stacking direction; and (3) calculating the absolute value of the difference between those two compression rates in percentage points.

In an exemplary embodiment of the present invention, the compression rate of the separator located at the outermost ends of the electrode assembly may be 3% to 8%, preferably 4% to 8%.

In an exemplary embodiment of the present invention, the compression rate of the separator located in the middle of the electrode assembly may be 3% to 8%, preferably 4% to 8%.

In an exemplary embodiment of the present invention, the compression rate of the separator located at the outermost ends of the electrode assembly may be 3% to 8%, preferably 4% to 8%, and the compression rate of the separator located in the middle of the electrode assembly may be 3% to 8%, preferably 4% to 8%.

The compression rate of the separator may be calculated by taking a difference between a thickness of the supplied separator (fabric thickness, before the process) and a thickness of the separator after completion of the electrode assembly (after the process), and then dividing that difference by the thickness of the supplied separator before the process. The result can be multiplied by 100 to yield percentage points.

In an exemplary embodiment of the present invention, after completion of the process, the thickness of the separator located in the middle of the electrode assembly may be 1 to 1.09 times, preferably greater than 1 time and equal to or less than 1.09 times, more preferably greater than 1 time and equal to or less than 1.05 times, and most preferably greater than 1 time and equal to or less than 1.03 times the thickness of the separator located at the outermost ends of the electrode assembly.

That is, in an exemplary embodiment of the present invention, in the electrode assembly, the thickness of the separator located at the outermost ends of the electrode assembly may be less than the thickness of the separator located in the middle of the electrode assembly, and the thickness of the separator located in the middle of the electrode assembly may be equal to or less than 1.09 times the thickness of the separator located at the outermost ends of the electrode assembly.

In an exemplary embodiment of the present invention, a thickness deviation of the separator of the electrode assembly may be 9% or less, preferably 5% or less, and more preferably 3% or less. That is, after completion of the process, the thickness of the separator located at the outermost ends of the electrode assembly and the thickness of the separator located in the middle of the electrode assembly may be obtained. Then, the absolute value of the difference between those thicknesses can be taken and divided by the average thickness of the separator. Multiplying that result by 100 will yield percentage point values for the thickness deviation noted above.

The electrode assembly according to the present invention is manufactured by heating and pressing a stack (unfinished electrode assembly) in which electrodes and a separator are stacked. Here, since the thickness deviation between the outermost portion of the separator and the middle portion of the separator is the largest, it is possible to check whether the thickness deviation of the separator is within a particular numerical range by comparing the thicknesses of the portion of the separator at the outermost ends versus that in the middle of the stack.

An exemplary embodiment of the present invention provides an electrode assembly including a first electrode, a separator, and a second electrode, in which the electrode assembly is stacked in a zigzag form, and the electrode assembly is heated and pressed to provide an electrode assembly that satisfies the below equation after the zigzag stacking:

$$1.02 {E}_{A} \leq {E}_{B}$$

wherein,
E_{A} is the energy density (Wh/L) of the electrode assembly before heating and pressing, and
E_{B} is the energy density (Wh/L) of the electrode assembly after heating and pressing.

In an exemplary embodiment of the present invention, the electrode assembly may satisfy Equation 1 below. Specifically, Equation 1 may be 1.02E_{A}≤E_{B}, preferably 1.03E_{A}≤E_{B}. That is, the energy density (Wh/L) increases as the separator and the electrodes are compressed during the heating and pressing. In this case, the energy density means power per volume.

The energy density is a value calculated by disassembling the electrode assembly, obtaining energy densities at the outermost and middle positions of the electrode assembly and then averaging values.

In an exemplary embodiment of the present invention, the compression rate of the separator located at the outermost ends of the electrode assembly may be greater than the compression rate of the separator located in the middle of the electrode assembly along the stacking direction.

The electrode assembly according to the present invention has uniform performance and better withstand voltage because the thickness of the separator is uniform.

In an exemplary embodiment of the present invention, the withstand voltage of the electrode assembly may be 1.5 kV or higher.

In addition, the description of the electrode assembly manufacturing apparatus and the configuration of the manufacturing apparatus according to the present invention can also be applied to the manufacturing method according to the present invention and the electrode assembly manufactured by the manufacturing method according to the present invention.

In an exemplary embodiment of the present invention, the air permeability of a portion of the separator located in the middle of the electrode assembly along the stacking direction may be 80 sec/100 ml to 120 sec/100 ml, preferably 80 sec/100 ml to 110 sec/100 ml, and more preferably 85 sec/100 ml to 100 sec/100 ml.

In addition, in an exemplary embodiment of the present invention, the air permeability of a portion of the separator located at the outermost ends of the electrode assembly in the stacking direction may be 80 sec/100 ml to 120 sec/100 ml, preferably 80 sec/100 ml to 110 sec/100 ml, and more preferably 85 sec/100 ml to 100 sec/100 ml.

According to an exemplary embodiment of the present invention, the deviation between the air permeability of the separator located in the middle of the electrode assembly and the air permeability of the separator located at the outermost ends of the electrode assembly along the stacking direction may be 2 sec/100 ml to 15 sec/100 ml, and preferably 2 sec/100 ml to 10 sec/100 ml.

Although the exemplary embodiments of the present invention have been described in detail, it will be obvious to one skilled in the art that the scope of the present invention is not limited thereto, but rather various modifications and variations can be made without departing from the technical spirit of the present invention defined in the claims.

### <Manufacture of Electrode Assembly>

### 1) Example 1

19 (nineteen) positive electrodes, 20 (twenty) negative electrodes, and a separator were supplied to the stack table from the positive electrode supply unit, the negative electrode supply unit, and the separator supply unit, respectively.

More specifically, the positive electrodes and the negative electrodes were supplied by being cut from a positive electrode sheet and a negative electrode sheet, respectively, and the separator was supplied in the form of a separator sheet. In this case, the positive electrode and the negative electrode were each manufactured to have a positive electrode tab and a negative electrode tab, respectively. Thereafter, the supplied separator was repeatedly folded while rotating the stack table back and forth, so as to stack the positive electrodes, the negative electrodes, and the separator.

In this case, the positive electrode and the negative electrode were each supplied using an electrode stacking unit including a suction head, an electrode non-contact heater, and a moving unit.

The stacking of the positive electrode or negative electrode on the uppermost side of the stack table was performed in conjunction with the use of a holding mechanism 170 like that illustrated in FIG. 2.

Subsequently, the stack was inductively heated for 15 seconds (induction heating process) with an induction heating unit including a U-shaped induction heating coil. Thereafter, the stack was allowed to stand by for 15 seconds (standby process). After the standby process, the electrode tab of the stack was inductively heated for 15 seconds (electrode tab induction heating process) with an electrode tab induction heating unit including a U-shaped induction heating coil. Subsequently, the electrode assembly of Example 1 was manufactured by heating and pressing (heating and pressing process) the stack for 15 seconds under a temperature condition of 70° C. and a pressure condition of 3.5 MPa.

During the manufacturing process, the surface temperature change of the stack S was measured. Specifically, a heated part, which was heated by the U-shaped induction heating coil, and an unheated part (i.e., the upper or lower surface of the stack S contacted by the fixing part 51b when the gripper holds the stack), which was not heated by the U-shaped induction heating coil, were distinguished from the surface of the stack S, and the temperature change was measured for each part. The result is shown in FIG. 9.

Subsequently, the adhesive force pattern of the electrode assembly of Example 1 was measured using an adhesive force meter according to the method described below, and the result is shown in FIG. 9. Specifically, the adhesive force between the separator and an electrode was measured across a surface of the electrode in the direction of the arrow shown in FIG. 9.

From the result of FIG. 9, it could be confirmed that the surface temperature of the stack can be increased when the induction heating process is performed. In particular, it could be confirmed that since induction heating can be performed for an electrode not located at the outermost end of the stack that is not in direct contact with the heating and pressing unit, temperature non-uniformity between electrodes in the heating and pressing process can be prevented.

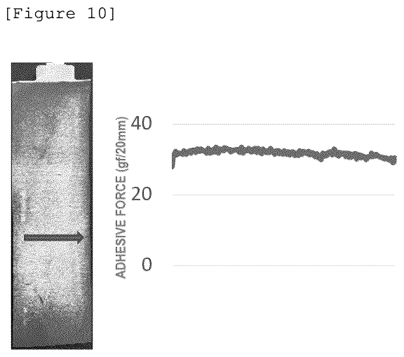

In addition, from the result of FIG. 9, it could be confirmed that the temperature deviation between the heated part and the unheated part can also be reduced when the standby process is performed. It could be confirmed that since the temperature deviation was reduced, the adhesive force pattern of the electrode assembly was uniform as shown in FIG. 10.

Additionally, it was confirmed that the electrode tab portion was also uniformly bonded by inductively heating the electrode tab portion.

### 2) Comparative Example 1

An electrode assembly of Comparative Example 1 was manufactured in the same manner as in Example 1, except that the induction heating, the electrode tab induction heating and the standby process were not performed in Example 1.

### Experimental Example 1—Evaluation of Thickness Change of Separator Fabric and Compression Rate of Separator

For the electrode assemblies of Example 1 and Comparative Example 1, the thickness change of the separator fabric and the compression rate of the separator were evaluated.

Specifically, after measuring the thickness of the separator fabric before stacking, the electrode assemblies of Example 1 and Comparative Example 1 were disassembled. The separator located at the top (outermost) of the electrode assembly in the stacking direction and the separator corresponding to the middle position (central portion) of the electrode assembly in the stacking direction were collected, and the thickness change of the separator fabric before and after the process was measured, and the results are shown in Table 1 below. In addition, the compression rate of the separator was also calculated from the thickness change of the separator fabric and is shown in Table 1 below.

TABLE 1

| | | Separator | | Separator | |
|---|---|---|---|---|---|
| | | fabric thickness (μm) | | compression rate (%) | |
| | | central | | central | |
| | | portion | outermost | portion | outermost |
| Example 1 | before | 9.8 | | 6 | 7 |
| | process | | | | |
| | after | 9.3 | 9.2 | | |
| | process | | | | |
| Comparative | before | 9.8 | | 0 | 9 |
| Example 1 | process | | | | |
| | after | 9.8 | 8.9 | | |
| | process | | | | |

As can be seen in Table 1, it can be confirmed that when the induction heating and the standby process were not performed, the change deviation in the fabric thickness of the separator was large, and that the fabric thickness of the separator at the outermost end was reduced more than necessary and the fabric thickness of the separator in the central portion changed relatively little. That is, in Comparative Example 1, unlike Example 1, it could be confirmed that the deviation in the thickness of the separator was large depending on the position of the electrode assembly.

This means that it is difficult for the electrode assembly to have uniform performance independent of location in the electrode assembly. That is, it could be confirmed that the electrode assembly manufactured by the manufacturing apparatus and method according to the present invention has more uniform performance.

### Experimental Example 2—Evaluation of Withstand Voltage

The withstand voltage was evaluated for the electrode assemblies of Example 1 and Comparative Example 1.

The results are shown in Table 2 below.

TABLE 2

| | Withstand voltage (kV) |
|---|---|
| Example 1 | 1.58 |
| Comparative Example 1 | 1.17 |

As can be seen from Table 2, it could be confirmed that when the induction heating and the standby process are performed, the withstand voltage is better than when the induction heating and the standby process are not performed. That is, in Comparative Example 1, it could be confirmed that the withstand voltage performance was not as good as that of Example 1.

### Experimental Example 3—Evaluation of Air Permeability of Separator

After disassembling the electrode assemblies of Example 1 and Comparative Example 1, portions of the separator from the middle position and the upper and lower ends of the electrode assembly in the stacking direction were collected. The separators were each cut to prepare a separator sample with a size of 5 cm×5 cm (length×width). Thereafter, the separator samples were washed with an organic solvent.

Then, air permeability of the separator was measured. The method for measuring the air permeability of the separator is not particularly limited. In the method utilized and discussed further herein, the air permeability was measured by using a method according to the JIS Gurley measurement method of the Japanese industrial standard using a Gurley type Densometer (No. 158) manufactured by Toyoseiki Company. That is, the air permeability of the separators in Example 1 and Comparative Example 1 were obtained by measuring the time it takes for 100 ml (or 100 cc) of air to pass through the separator of 1 square inch under a pressure of 0.05 MPa at room temperature (i.e., 20° C. to 25° C.).

The results are shown in Table 3 below.

TABLE 3

| | | Air permeability of |
|---|---|---|
| | Induction heating applied | separator |
| | (standby process) | (sec/100 ml) |
| Example 1 | ◯ | 97 |
| Comparative | X | 98 |
| Example 1 | | |

As can be seen in Table 3, it could be confirmed that Example 1 and Comparative Example 1 had similar air permeability.

From the above experimental examples, it could be confirmed that the electrode assembly manufactured by the electrode assembly manufacturing apparatus and method of the present invention is excellent in terms of stability of the electrodes and separator and has an appropriate level of air permeability at which deformation of the separator does not occur.

In addition, it could be confirmed that an electrode assembly having excellent withstand voltage and uniform performance can be manufactured.

What is claimed is:

1. A method for manufacturing an electrode assembly, comprising:
stacking a first electrode, a separator, and a second electrode into a stack along a stacking axis, wherein the first electrode includes a first electrode tab;
applying heat from a first source of heat to a first portion of the stack;
applying heat from a second source of heat to a second portion of the stack while applying pressure to the stack; and
applying heat from a third source of heat to the first electrode tab,
wherein the first, second, and third sources of heat are controllable independently of one another.

2. The method of claim 1, further comprising stopping the application of heat from the first source to the first portion of the stack for a predetermined time period between the step of applying heat from the first source to the first portion of the stack and the step of applying heat from the second source of heat to the second portion of the stack.

3. The method of claim 2, wherein the predetermined time period is in a range from 3 seconds to 60 seconds.

4. The method of claim 2, wherein the step of applying heat from the third source of heat to the first electrode tab occurs between the step of applying heat from the first source to the first portion of the stack and the step of applying heat from the second source of heat to the second portion of the stack.

5. The method of claim 4, wherein the step of applying heat from the third source of heat to the first electrode tab occurs after stopping the application of heat from the first source to the first portion of the stack for the predetermined time period.

6. The method of claim 1, wherein the third source of heat is an induction heating coil, such that the step of applying heat from the third source of heat to the first electrode tab comprises applying induction heating from the induction heating coil to the first electrode tab.

7. The method of claim 6, wherein the first source of heat is a second induction heating coil, such that the step of applying heat from the first source of heat to the first portion of the stack comprises applying induction heating from the second induction heating coil to the first portion of the stack.

8. The method of claim 7, wherein the step of applying heat from the second source of heat to the second portion of the stack comprises applying direct heating by conduction and/or radiation to the second portion of the stack.

9. The method of claim 8, wherein the second portion of the stack is at least one of the top portion and the bottom portion of the stack along the stacking axis, and wherein the first portion of the stack is a central portion of the stack disposed between the top and bottom portions along the stacking axis.

10. The method of claim 1, wherein the step of applying heat from the third source of heat to the first electrode tab is performed for a time period in a range from 1 second to 60 seconds.

11. An apparatus for manufacturing an electrode assembly, comprising:
a stack table on which a first electrode, a separator, and a second electrode are configured to be stacked into a stack, wherein the first electrode includes a first electrode tab; and
a heating and pressing unit configured to apply heat and pressure to the stack; and
an electrode tab heating unit configured to apply heat to the first electrode tab, the electrode tab heating unit being controllable independently of the heat applied by the heating and pressing unit.

12. The apparatus of claim 11, wherein the electrode tab heating unit includes an induction heating coil for applying induction heating to the first electrode tab.

13. The apparatus of claim 12, further comprising an induction heating unit including a second induction heating coil configured to apply induction heating to the stack.

14. The apparatus of claim 12, wherein the heating and pressing unit includes a non-inductive heat source for applying conduction and/or radiation to the stack.

15. An electrode assembly, comprising:
a plurality of electrodes arranged in a stack along a stacking axis, wherein each of the electrodes in the stack is separated along the stacking axis from a successive one of the electrodes in the stack by a respective separator portion positioned therebetween,
wherein the separator portions include a first separator portion and a second separator portion, the first separator portion being positioned in a central portion of the stack between a top portion and a bottom portion of the stack along the stacking axis, and the second separator portion being positioned in at least one of the top portion and the bottom portion of the stack along the stacking axis, and
wherein the second separator portion has a second thickness from 1 to 1.09 times a first thickness of the first separator portion.

16. The electrode assembly of claim 15, wherein the second thickness of the second separator portion is from 1 to 1.05 times the first thickness of the first separator portion.

17. The electrode assembly of claim 16, wherein the second thickness of the second separator portion is from 1 to 1.03 times the first thickness of the first separator portion.

18. The electrode assembly of claim 15, wherein the first and second separator portions are portions of an elongated separator sheet, the elongated separator sheet being folded between each of the separator portions such that the elongated separator sheet follows a serpentine path traversing back and forth along an orthogonal dimension orthogonal to the stacking axis to extend between each successive one of the electrodes in the stack.

19. The electrode assembly of claim 15, wherein the electrode assembly has a full length in a range from 400 mm to 600 mm and has a full width in a range from 50 mm to 150 mm.

20. The electrode assembly of claim 15, wherein the first and second separator portions each have an air permeability in a range from 80 sec/100 ml to 120 sec/100 ml.
